(19) United States
(12) Patent Application Publication
(10) Pub. No.: US 2018/0153650 A1
(43) Pub. Date: Jun. 7, 2018

(54) DENTAL WIRE CAP

(71) Applicant: Erksine holdco Pty Ltd, Macksville, New South Wales (AU)

(72) Inventor: Craig Mathew ERSKINE-SMITH, North Curl Curl, New South Wales (AU)

(21) Appl. No.: 15/575,326

(22) PCT Filed: Jan. 27, 2016
(86) PCT No.: PCT/AU2016/000014

§ 371 Date: Nov. 17, 2017

(30) Foreign Application Priority Data
May 19, 2015 (AU) 2015901808

(51) Int. Cl. A61C 7/12

(52) U.S. Cl. CPC A61C 7/125

(57) ABSTRACT

A dental (orthodontic) wire cap 10 that is intended to receive the end portion 11 of a dental wire. The end portion 12 is intended to have its end extremity located internally of the cap 10 so that the end extremity of the end portion 11 is located internally of the cap 10 to thereby minimise risk of irritation to the cheek of the user.

### FIELD

The present invention relates to orthodontic devices.

### BACKGROUND OF THE INVENTION

Orthodontic wires have a disadvantage in that they are inclined to protrude from the distal aspect of the last distal bracket they are attached to. As the wire protrudes more and more it can cause irritation and ulceration to the cheek. It can even extend so far that it can snag and impale the buccal mucosa and cause an emergency. Although there have been many devices invented to trim off the distal aspect of the wire such as the distal wire cutter, this sometimes only provides relief to the patient for a short period of time because as the teeth straighten so the wire tends to protrude more from the distal end of the last bracket. Cinching back the wire cannot be done if the wire is to be inserted into and through a buccal tube, as is commonly used. Cinching back the wire after it is inserted through the buccal tube is very awkward if not impossible when the wire is made of highly resilient nickel titanium alloy, as is commonly employed in the level and align phase of orthodontics. Metal wire caps that can be swaged or crimped onto the wire may not hold onto the wire with active tension and lose their retention. Composite resin balls that can be formed on the end of the wire usually need an extra step of drilling a notch at the end of the wire to avoid the ball falling off, and are fiddly and time consuming to place and cure.

### OBJECT OF THE INVENTION

The object of the present invention is to overcome or substantially ameliorate the above disadvantage.

### SUMMARY OF INVENTION

There is disclosed herein a dental wire cap, the cap being configured to engage an end portion of a dental wire, the cap including:
a first cap part and a second cap part, each cap part including an aperture, with the apertures being at a position at which the apertures are at least partly not aligned so that the end portion cannot pass through the apertures; and
a resilient member located between the portions, the resilient member being compressed between the cap parts to align the apertures to provide for the insertion of the end portion into the cap so that the end portion can pass through the apertures to be enclosed by the cap, and that upon release of the cap parts, the cap parts are urged apart, by the resilient member, so that apertures are urged to said position so that the cap parts will engage the end portion to secure the end portion to the cap.

Preferably, the first cap part, second cap part and the resilient member are secured together so that the apertures are located at said position when the resilient member is not compressed.

Preferably, the first cap part, the second cap part and the resilient member are assembled so as to be secured together with the apertures at said position.

In an alternative preferred form, the resilient member is moulded between the first cap part and second cap part with the apertures at said positions.

In a still further alternative preferred form, the resilient member is secured to the first cap part and the second cap part by an adhesive so that the apertures are at said positions.

Preferably, the resilient member is provided with abutments, and each cap part is provided with at least one projection that engage a respective one of the abutments to secure the cap parts to the resilient member with the apertures at said position.

Preferably, the resilient member is deformed by engagement with the projections to provide for movement of the projections to a position at which the abutments are engaged by the projections to secure the cap parts to the resilient member.

Preferably, the first cap part, and the second cap part have recesses into which the projections engage.

Preferably, the projections engage in the recesses so that at least one of the projections of the first cap part or the second cap part engages the other cap part to limit movement of the two cap parts towards each other and to define the position at which the apertures are aligned.

Preferably, at least one of the cap parts has surfaces that engage the other cap part to aid in guiding movement between the first cap and the second cap part.

Preferably, each projection has a ramp surface to engage an associated one of the abutments, and a surface to engage the associated abutment to inhibit separation of the cap parts.

Preferably, the resilient member has a generally central passage into which the projections are inserted to engage the resilient member.

Preferably, one of the cap parts has two projections, and the other cap part one projections.

Preferably, one of the projections provides a face against which the end portion can abut.

Preferably, the apertures allow insertion of the end portion, when the end portion is a wire of a diameter in the range of 0.010 inches to 0.020 inches and/or rectangular or square wire having transverse side dimensions not greater than 0.019×0.025 inches.

### BRIEF DESCRIPTION OF DRAWINGS

Preferred forms of the present invention will now be described by way of examples with reference to the accompanying wherein:

FIG. 1 is a schematic isometric view of a dental wire cap;

FIG. 2 is a schematic end elevation of the cap of FIG. 1;

FIG. 3 is a schematic side elevation of a cap of FIG. 1;

FIG. 4 is a schematic isometric of a cap of FIG. 1 prior to installation;

FIG. 5 is a schematic side elevation of the cap as shown in FIG. 4;

FIG. 6 is a schematic end elevation of the cap as shown in FIG. 4;

FIG. 7 is a schematic side elevation of the cap as shown in FIG. 4;

FIG. 8 is a schematic isometric parts exploded view of the cap of FIG. 1;

FIG. 9 is a further parts exploded isometric view of the cap of FIG. 1;

FIG. 10 is a schematic parts exploded side elevation of the cap of FIG. 1;

FIG. 11 is a parts exploded end elevation of the cap of FIG. 1;

FIG. 12 is a schematic isometric view of a lower part of the cap of FIG. 1;

FIG. 13 is a further schematic isometric view of the part of FIG. 12;

FIG. 14 is a schematic lower isometric view of the part of FIG. 12;

FIG. 15 is a schematic side elevation of the part of FIG. 12;

FIG. 16 is a top plan view of the part of FIG. 12;

FIG. 17 is a schematic end elevation of the part of FIG. 12;

FIG. 20 is a schematic bottom plan view of the part of FIG. 12;

FIG. 18 is a further schematic side elevation of the part of FIG. 12;

FIG. 19 is a further schematic end elevation of the part of FIG. 12;

FIG. 21 is a schematic isometric view of a resilient part used in the cap optical line;

FIG. 22 is a further schematic isometric view of the part of FIG. 21;

FIG. 23 is a still further isometric view of the part of FIG. 21;

FIG. 24 is a schematic top plan view of the part of FIG. 21;

FIG. 25 is a schematic end elevation of the part of FIG. 21;

FIG. 26 is a schematic side elevation of the part of FIG. 1;

FIG. 28 is a still further schematic end elevation of the part of FIG. 21;

FIG. 29 is a schematic isometric view of a further part of the cap of FIG. 1;

FIG. 30 is a still further isometric view of the part of FIG. 29;

FIG. 31 is a schematic bottom isometric view of the part of FIG. 29;

FIG. 32 is a schematic end elevation of the part of FIG. 29;

FIG. 33 is a schematic side elevation of the part of FIG. 29;

FIG. 34 is a schematic top plan view of the part of FIG. 29;

FIG. 35 is a schematic bottom plan view of the part of FIG. 29;

FIG. 36 is a still further schematic side elevation of the part of FIG. 29; and

FIG. 37 is a still further schematic side elevation of the part of FIG. 29.

### DETAILED DESCRIPTION OF EMBODIMENTS

In the accompanying drawings there is schematically depicted a dental (orthodontic) wire cap 10. The cap 10 is intended to receive the end portion 11 of a dental wire. The end portion 12 is intended to have its end extremity located internally of the cap 10 so that the end extremity of the end portion 11 is located internally of the cap 10 to thereby minimise the risk of irritation to the cheek of the user.

The cap 10 includes a first cap part 12 and a second cap part 13 between which there is located an intermediate part (resilient member) 14.

The parts 12 and 13 would be formed of metal or plastics material so as to be substantially rigid. The part 14 is formed of resilient material, such as plastics, rubber or synthetic rubber, so that in use the part 14 can be resiliently compressed between the parts 12 and 13.

When a compressive force is applied to the parts 12 and 13, to compress the part 14, the parts 12, 13 and 14 cooperate to provide a passage (cavity) 15 into which the end portion 11 of the wire projects so that the end extremity is enclosed by the cap 10.

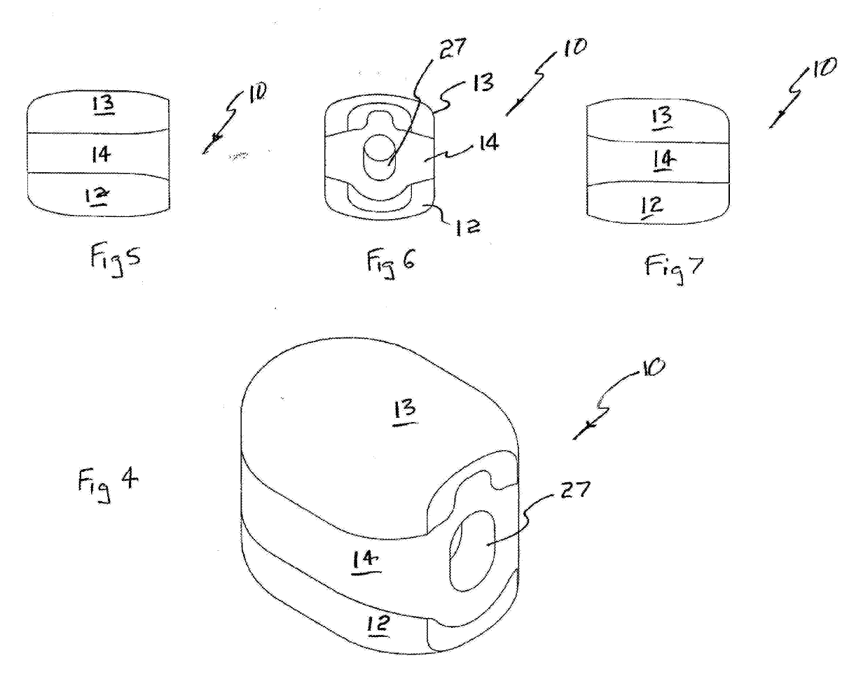

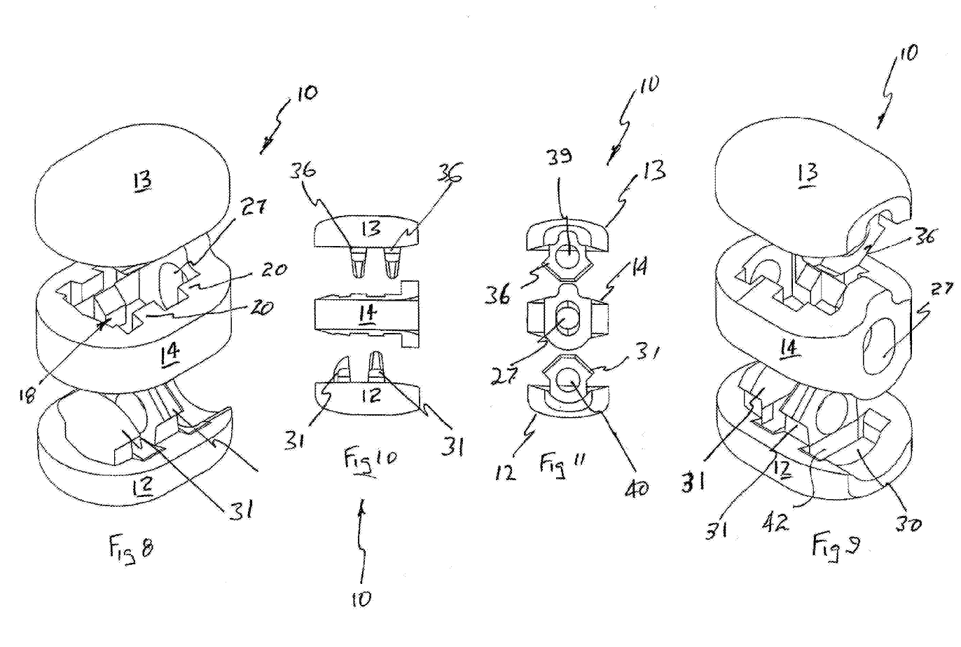

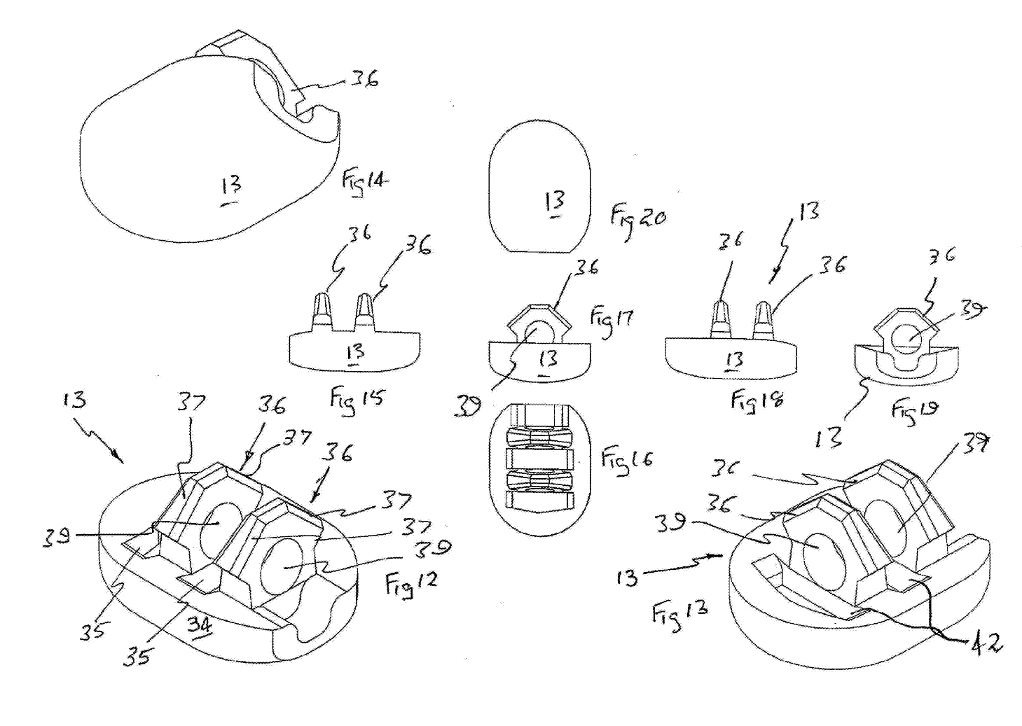

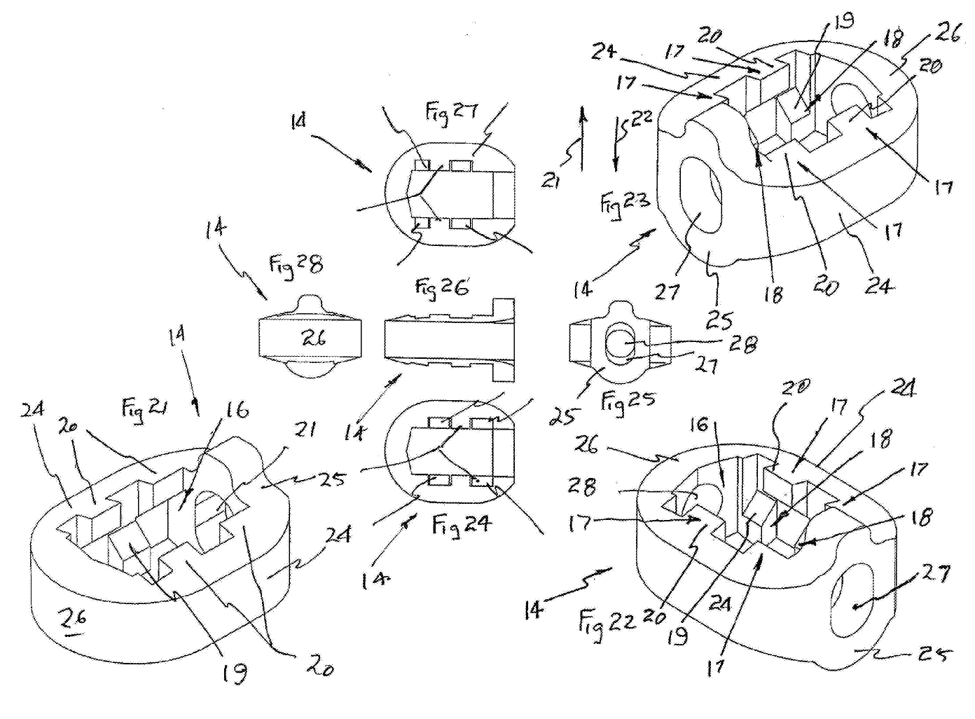

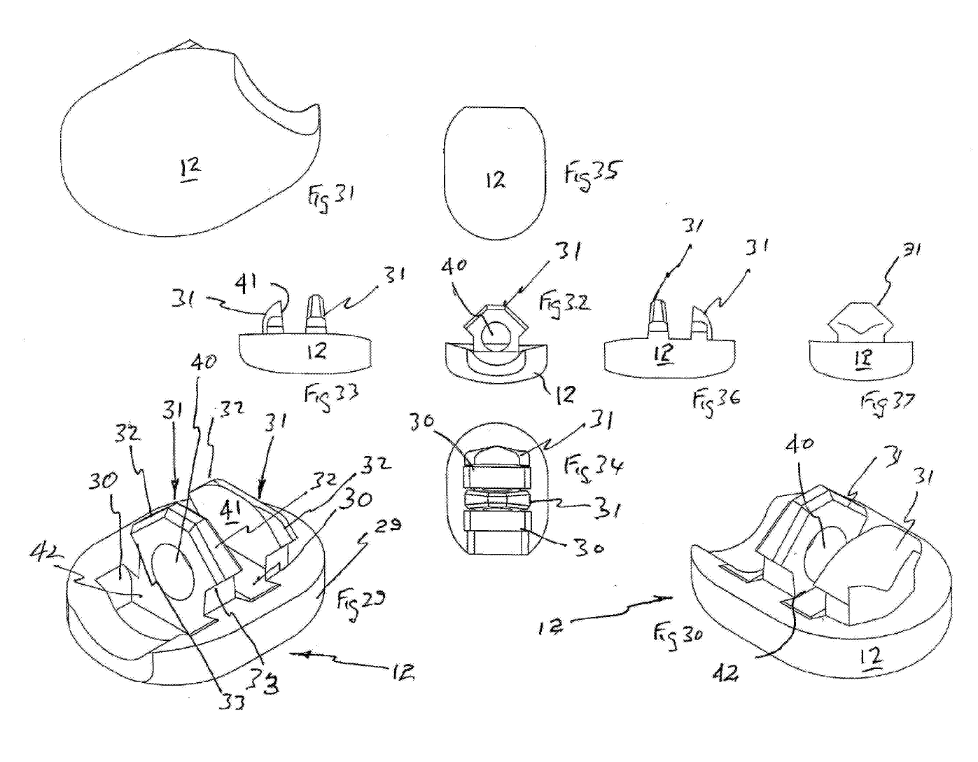

In FIG. 1, the cap 10 is illustrated with the part 14 compressed so as to provide the passage 15. In FIGS. 4 to 7, the part 14 is not compressed and therefore the passage 15 is not provided.

The part 14 has a central through passage 16 into which there projects opposing pairs of abutments 17 and 18 of the part 14. Each abutment 17 and 18 has a ramp surface 19 and an abutment surface 20. The surfaces 20 of the abutments 17 face in the direction 21, while the surfaces 20 of the abutments 18 face in the direction 22.

The part 14 has side walls 26, from which the abutments 17 and 18 project, and end walls 25 and 26. The end wall 25 has an aperture 27 through which the end portion 11 can project when being inserted in the passage 15. In that regard the aperture 27 forms part of the passage 15.

The end wall 26 is provided with a recess 28 that does not extend all the way through the wall 26.

The passage 27 is aligned with the recess 28.

The part 12 includes a plate portion 29 that has recesses 30, and from which there extends projections 31. The projections 31 have leading surfaces 32 and trailing surfaces 33. The projections 31 are inserted in the passage 16 to engage abutments 17. With reference to FIG. 23, the projections 31 are inserted in the passage 16 in the direction 21. The surfaces 32 engage the ramp surfaces 19 of the abutments 17, while once passed the abutments 17, the surfaces 32 engage the surfaces 20. Accordingly, the part 12 is then attached to the part 14. As the part 14 is resilient, the part 14 resiliently deforms to provide for movement of the surfaces 32 and 33 past the abutments 17.

The part 13 includes a plate portion 34 that has recesses 35, and from which there extends projections 36. Each of the projections 36 includes leading surfaces 37 and trailing surfaces 38.

When the part 13 is applied to the part 12, by moving it in the direction 22 to insert the projections 36 in the passage 16, the surface 37 engages the surfaces 19 of the abutment 18, with the surfaces 38 engaging the surfaces 20 when the surfaces 38 have passed the abutment 18. Accordingly, the part 13 is attached to the part 14. The cap part 14 resiliently deforms to enable movement of the surfaces 37 and 38 past the abutments 18.

When the parts 12, 13 and 14 are attached and the part 14 compressed, the projections 31 extend into the recess 35, while the projections 36 extend into the recesses 30.

Each of the projections 36 has a passage 39, while only one of the projection 31 has a passage 40. The projections 36 most remote from the passage 27 has a face 41 against which the end extremity of the end portion 11 may abut to define the preferred location of the end portion 11 within the cap 10.

The parts 12, 13 and 14 are connected as described above, so that the parts 12, 13 and 14 stay together. However, when the passage 27, and apertures 39 and 40, are all not aligned the passage 15 is not provided. However, upon compression of the part 14, as described above, the passages 39 and 40 are moved into alignment together with the passage 27, so that the passage 15 is now provided and the end portion 11 can be inserted. The end extremity of the end portion 11 passes through the aperture 27, and apertures 39 and 40 to abut the face 41. The end portion 11, once located in the passage 15, prevents the cap 10 returning to its initial assembled state as shown in FIGS. 4 to 7 with the part 14 not compressed. The projections 31 and 36 apply a constant force to the end portion 11 by being urged into contact therewith.

When the end portion 11 is located in the passage 15, and the cap parts 12 and 13 released, the cap parts 12 and 13 are urged apart, together with the apertures 39 and 40, so that the projections 31 and 36 engage the end portions 11. That is the cap parts 12 and 13 are urged to the “rest position” but are prevented from doing so by the end portion 11 extending through the projections 31 and 36.

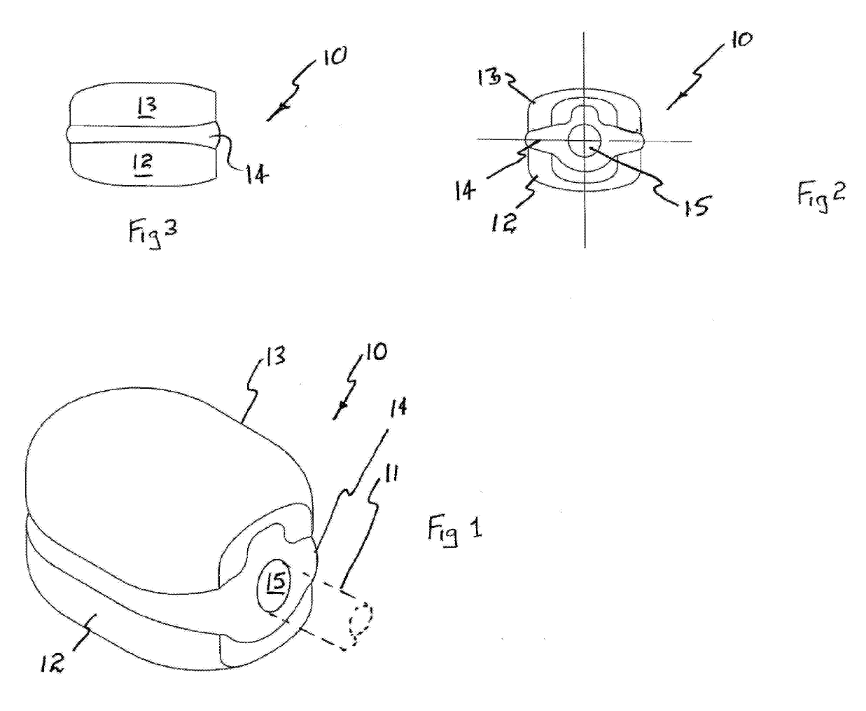

As best seen in FIGS. 2 and 3, preferably the part 14 “bulges” when compressed so as to extend beyond the parts 12 and 13.

The recesses 30 and 35 have internal surfaces 42, facing a respective recess 30 or 35, that slidably engage the associated projection 31 or 36 to guide the cap parts 12 and 13 in their relative movement to aid in assisting the cap parts 12 and 13 to remain essentially with their plate portions 29 and 34 generally parallel.

Due to the resilient nature of the part 14, the end portion 11 is clamped in the cap 10 by a “guillotine” interaction between the projection 31 and 36 and the end portion 11.

To remove the cap 10, the dental professional merely applies a compression force to the part 12 and 13 to align the apertures 39 and 40 to release the end portion 11.

The above described embodiments reduce irritation to the cheek by providing a removable cover (cap 10) of a sufficient size to not irritate the cheek.

In the preferred embodiments, the cap 10 is approximately 3 mm wide (1.5-4 mm) and approximately 3 mm (1.5-4 mm) high and approximately 4 mm long (1.5-6 mm) in the mesial-distal dimension.

The cap 10 may be marginally smaller than the above preferred embodiment without causing tissue irritation. However, the cap 10 should preferably not be much larger in order to avoid mouth aggravation by virtue of its size and perceived lumpiness.

The above preferred embodiments are easy to place and easy to remove. The cap 10 has the plate portions 29 and 34 externally rounded to minimise the possibility of irritation.

The face 41 acts as a back stop to limit the amount that the end portion 11 can protrude into the cap 10. This prevents the wire coming out the cap 10, thereby minimising the possibility of the wire irritating the cheek.

These internal projections 31 and 36 are hidden generally by the part 14. The projection 31 and 36 engage the part 14 when the part 14 is fully compressed and the passage 15 formed. The degree of the compression of the part 14 is determined by the projections 31 and 36 bottoming out in the recesses 30 and 35. This allows the operator to apply on a wide variety of excessive forces and still not cause any problem with alignment.

In the above preferred embodiments, the part 14 reduces the assembly time and obviates the need to drill a hole through the elastomeric material in the compressed state.

In the above described preferred embodiments the parts 12, 13 and 14 are separately formed and then assembled. In an alternative embodiment, cap parts 12 and 13 could merely be provided with the projections 31 and 36, including the passages 39 and 40. The part 14 could be moulded between the parts 12 and 13 so as to be secured thereto and to maintain the projections 39 and 40 at a position at which the passages 39 and 40 are not fully aligned. Thereafter, as discussed above, a compressive force would be applied to the parts 12 and 13 to compress the part 14 to bring the passages 39 and 40 into alignment. Thereafter the end portion 11 could be inserted through the passages 39 and 40 by piercing the part 14, if the part 14 is not formed with a passage enabling insertion of the end portion 11.

In a still further embodiment, the part 14 could be secured to the parts 12 and 13 by an adhesive rather than having the projections 31 and 36 engage abutment 17 and 18. Again the part 14 would be compressed to align the passages 39 and 40.

In the preferred embodiment only one size of passage is required which typically will accommodate from 0.008 up to 0.019×0.025″ rectangular wire. Given some room for error the preferred passage size for large wires is 0.9 mm. Provided the passages do not overlap too much in the passive state then this cap 10 may be used for the smaller wires used in orthodontics such as 0.010 inches diameter. In an alternative embodiment the cap is made with 0.208 inch diameter passages which will then accommodate the most popular wire sizes of 0.12 0.14 0.16 and 0.18 and 0.020. However this will not accommodate the larger rectangular wires such as the 0.019×0.025. These small round wire sizes are particularly useful in the levelling and aligning phase during which a large amount of wire can protrude from the distal aspect of the last bracket as the anterior teeth level and align, and the length of the wire needed to accommodate the crowding gradually reduces.

1. A dental wire cap, the cap being configured to engage an end portion of a dental wire, the cap including:
a first cap part and a second cap part, each cap part including an aperture, with the apertures being at a position at which the apertures are at least partly not aligned so that the end portion cannot pass through the apertures; and
a resilient member located between the portions, the resilient member being compressed between the cap parts to align the apertures to provide for the insertion of the end portion into the cap so that the end portion can pass through the apertures to be enclosed by the cap, and that upon release of the cap parts, the cap parts are urged apart, by the resilient member, so that apertures are urged to said position so that the cap parts will engage the end portion to secure the end portion to the cap.

2. The dental wire cap of claim 1 wherein the first cap part, second cap part and the resilient member are secured together so that the apertures are located at said position when the resilient member is not compressed.

3. The dental wire cap of claim 1 wherein the first cap part, the second cap part and the resilient member are assembled so as to be secured together with the apertures at said position.

4. The dental wire cap claim 1 wherein the resilient member is moulded between the first cap part and second cap part with the apertures at said positions.

5. The dental wire cap of claim 1 wherein the resilient member is secured to the first cap part and the second cap part by an adhesive so that the apertures are at said positions.

6. The dental wire cap of claim 1 wherein the resilient member is provided with abutments, and each cap part is provided with at least one projection that engage a respective one of the abutments to secure the cap parts to the resilient member with the apertures at said position.

7. The dental wire cap of claim 6 wherein the resilient member is deformed by engagement with the projections to provide for movement of the projections to a position at which the abutments are engaged by the projections to secure the cap parts to the resilient member.

8. The dental wire cap of claim 7 wherein the first cap part, and the second cap part have recesses into which the projections engage.

9. The dental wire cap of claim 8 wherein the projections engage in the recesses so that at least one of the projections of the first cap part or the second cap part engages the other cap part to limit movement of the two cap parts towards each other and to define the position at which the apertures are aligned.

10. The dental wire cap of claim 6 wherein each projection has a ramp surface to engage an associated one of the abutments, and a surface to engage the associated abutment to inhibit separation of the cap parts.

11. The dental wire cap of claim 6 wherein the resilient member has a generally central passage into which the projections are inserted to engage the resilient member.

12. The dental wire cap of claim 6 wherein one of the cap parts has two projections, and the other cap part one projections.

13. The dental wire cap of claim 6 wherein one of the projections provides a face against which the end portion can abut.

14. The dental wire cap of claim 1 wherein the apertures allow insertion of the end portion, when the end portion is a wire of a diameter in the range of 0.010 inches to 0.020 inches and/or rectangular or square wire having transverse side dimensions not greater than 0.019×0.025 inches.

15. The dental wire cap of claim 1 wherein at least one of the cap parts has surfaces that engage the other cap part to aid in guiding movement between the first cap and the second cap part.
